(19) United States
(12) Patent Application Publication
(10) Pub. No.: US 2004/0157967 A1
(43) Pub. Date: Aug. 12, 2004

(54) Polylactic acid compositions and molded products thereof

(75) Inventor: Fumio Ito, Hamamatsu-shi (JP)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Suzuki Motor Corporation

(21) Appl. No.: 10/764,376

(22) Filed: Jan. 23, 2004

(30) Foreign Application Priority Data
Jan. 27, 2003 (JP) 2003-016914

(51) Int. Cl. C08K 5/15

(52) U.S. Cl. 524/109; 524/556

(57) ABSTRACT

A polylactic acid composition comprising polylactic acid and at least one metal phosphate of the formula:

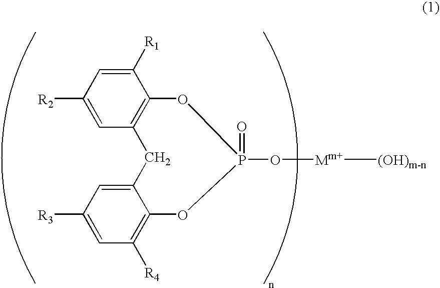

wherein R₁, R₂, R₃, and R₄ each independently represents hydrogen or alkyl, which may be the same or different, M represents a metal atom, and m and n each independently represents an integer of 1 to 3 where the m is equal to or larger than n.

### BACKGROUND OF THE INVENTION

1. Field of the Invention

The present invention relates to molded products of biodegradable plastic products, particularly to polylactic acid compositions and methods for making molded products of polylactic acid. More particularly, the present invention relates to polylactic acid compositions comprising a polylactic acid as a major ingredient, which can be highly crystallized in a short molding cycle and have an improved deflection temperature under load and superior heat resistance, and relates to the methods for making molded products of polylactic acid.

2. Description of the Related Art

Recently, from environmental concerns, improvement of recycling rates in automobile components and use of materials with low environmental load have been desired. In such circumstances, aliphatic polyester such as polylactic acid has drawn an attention as an environmentally friendly material, which is easily hydrolyzed in the presence of water. A polylactic acid can degrade after disposition without polluting the environment. In particular, because a polylactic acid is a recyclable material produced from the starch of maize and is environmentally friendly, a polylactic acid is promising material for car components and the others.

However, heat resistance of the polylactic acid is not sufficient for automobile products. Polylactic acid products are hardly crystallized by the general method in which a kneaded composition is melted and then molded at a mold temperature of a glass transition temperature (about 60° C.) or below. When the product is exposed to a temperature around the glass transition temperature, the elastic modulus is excessively reduced and the product is deformed. To improve the heat resistance, the molded product can be heated to increase the degree of crystallinity. However, a dimensional change occurs along with the crystallization. In another method where the crystallization step is performed in a mold, the crystallization step takes a long period of time and productivity is not high. For these reasons, polylactic acid has been limited in the field of producing automobile products, which exposed to a high temperature and in the field of producing other products requiring heat resistance.

Conventional method for producing heat-resistant polylactic acid is disclosed in Japanese Patent Provisional Publication No. 10-120887. In the method, which is different from those of the standard molding technology where the molded product is taken out of a mold immediately following a molding step, a polylactic acid product is highly crystallized by keeping the molded product in a mold during molding step at a temperature around Tc (crystallization temperature) for an extended period of time. However, crystallization is not always sufficient and the desired heat resistance has not been obtained.

Additionally, disclosed is a method in which polylactic acid products are highly crystallized by the standard molding technology and subsequent annealing (heat treatment). In the method, the product is sometimes deformed during the process of crystallizing. The method is not suitable for producing products requiring dimensional accuracy or designed appearances on the surface.

Moreover, in the above-mentioned methods, special conditions in the process are required and production costs become high because the process takes a long time as compared with the case of common molding methods. Such time-consuming method is not exactly practical.

A specific example for promoting the crystallization rate of commonly used polymer materials may include a method in which all aromatic polyester fine powders as nuclear agents (additives to accelerate the crystallization, crystallization nuclear agents) are added to accelerate the crystallization of PET in Japanese Patent Provisional Publication No. 60-86156. In this method, major components of the fine powders are terephthalic acid and resorcin.

In Japanese Patent Provisional Publication No. 4-504731 (WO 90/01521), as a method for producing heat-resistant degradable polymer materials, disclosed is a method in which properties of hardness, strength and temperature resistance are changed by adding a filler material of an inorganic compound such as silica and kaolinite to lactide thermoplastic plastics. In the working example of the publication, a sheet having raised crystallinity is produced by adding 5% by weight of calcium lactate as the nuclear agent to L, DL-lactide copolymer and blending using a heated roll at 170° C. for 5 min. The highly crystallized sheet is excellent in strength but is cloudy with low transparency.

In Japanese Patent Provisional Publication No. 6-504799 (WO 92/04413), a method in which lactate and benzoate are added as the nuclear agents to the degradable polymers is disclosed. In the working example thereof, disclosed is a method comprising the steps of adding 1% of calcium lactate as the nuclear agent to the polylactide copolymer; performing injection molding in a mold retained at about 85° C. for 2 min; and annealing the molded polylactide copolymer at about 110° C. to 135° C. in the mold.

In Japanese Patent Provisional Publication No. 4-220456, disclosed is a method in which the molded products having properties of high crystallization rate, shortened molding cycle and an excellent dynamic nature is made. The method comprises the step of adding polyglycolic acid and a derivative thereof as a nuclear agents to poly-L-lactide; and raising the cooled mold temperature during injection molding to Tg (“Tg” denotes the glass transition temperature or the glass transition point, hereinafter the same) or above. As an working example in the publication, for 60 seconds of cooling time, the crystallinity without adding the nuclear agent is 22.6% whereas the crystallinity with the nuclear agent addition is 45.5%.

### SUMMARY OF THE INVENTION

The present invention provides a biodegradable polylactic acid composition and a polylactic acid molded product. The molded product has improved heat resistance, high impact resistance and has rigidity. Further, a method for producing the polylactic acid product with improved moldability is provided.

The present invention provides a polylactic acid composition comprising polylactic acid and at least one metal phosphate of the formula:

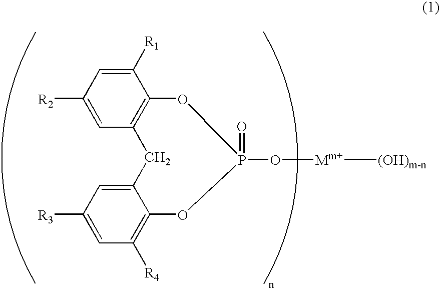

wherein R₁, R₂, R₃, and R₄ each independently represents the same or different hydrogen or alkyl, M represents a metal atom, and m and n each independently represents an integer of 1 to 3 where the m is equal to or larger than n.

The metal phosphate may include, but are not limited to, sodium 2,2-methylene-bis(4,6-di-tert-butylphenyl) phosphate, potassium 2,2-methylene-bis(4,6-di-tert-butylphenyl) phosphate, sodium 2,2-methylene-bis(4,6-di-methylphenyl) phosphate, aluminum 2,2-methylene-bis(4,6-di-tert-butylphenyl)phosphate hydroxide, calcium 2,2-methylene-bis(4,6-di-tert-butylphenyl)phosphate hydroxide.

A polylactic acid product made from the composition has a uniform fine crystal structure. The crystallization rate in the composition is accelerated.

Preferably, the metal phosphate is sodium 2,2-methylene-bis(4,6-di-tert-butylphenyl) phosphate or aluminum 2,2-methylene-bis(4,6-di-tert-butylphenyl)phosphate hydroxide. The polylactic acid product made from the composition has promoted degree of crystallinity of polylactic acid and an improved deflection temperature under load.

Preferably, provided is a polylactic acid composition wherein the metal phosphate is in a fibrous or oriented form. The elastic modulus of the molded product of the polylactic acid composition is improved. It is preferred that an amount of the metal phosphate or a mixture of the metal phosphates is 0.1% to 2% by weight based on the weight of the polylactic acid.

Preferably, the polylactic acid composition may further comprise any of talc, graphite or silica as a filler material. The filler material improves the crystallization rate of the polylactic acid and a deflection temperature under load. The polylactic acid composition may further comprise fatty acid amide. In a polylactic acid molded product made by crystallizing the polylactic acid composition, the impact resistance and a deflection temperature under load are improved by the fatty acid amide. The molded product can be useful for car components requiring a heat resistance.

Further, the present invention provides a polylactic acid molded product comprising a crystal structure. In the structure, the crystallinity may be 25% or more, a lattice spacing of the crystal may be from 5.2 to 5.5 angstroms and the crystallite size may be 400 angstroms or less. The polylactic acid product having the crystal structure may have superior heat resistance.

The present invention provides a method for making a polylactic acid molded product comprising steps of kneading a polylactic acid and at least one metal phosphate of the formula:

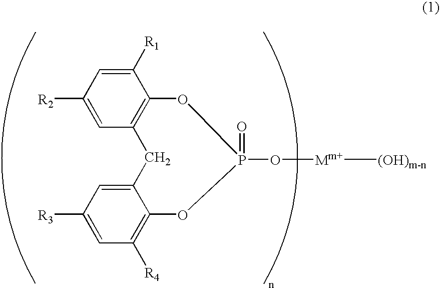

wherein R₁, R₂, R₃, and R₄ each independently represents hydrogen or alkyl, which may be the same or different, M represents a metal atom, and m and n each independently represents an integer of 1 to 3 where the m is equal to or larger than n,

to prepare a composition; melting the kneaded composition and casting the composition in a mold; and molding the composition at a temperature within the range of the crystallization temperature of the polylactic acid.

According to the method, the crystallinity and a deflection temperature under load of the molded product is improved. In the method, unevenness caused by weld and mixture with dissimilar materials can be suppressed.

Preferably, the method may further comprise after the molding step, a step of releasing the molded composition from the mold at a mold temperature within the range of the crystallization temperature. According to the method, the remaining heat of the molded composition can promote the crystallization of the polylalctic acid after the molded composition is released from the mold. This leads to the improved deflection temperature under load of the molded product and to the shortened molding cycle. It is not necessary to cool or heat the mold and thus heat efficiency is enhanced. Preferably the temperature range of crystallization of the polylactic acid may be about 80° C. to 140° C.

According to the polylactic acid composition, the polylactic acid molded product obtained from the composition and the method for production thereof are provided. The polylactic acid molded product has superior heat resistance and impact resistance. Automobile products according to the present invention are promising in terms of both functional and environmental embodiments.

A polylactic acid product having desirable heat resistance can be produced from metal phosphate as the nuclear agent and a polylactic acid, which is known to be biodegradable and be made from a natural material and has adaptability to the environment. Further, acceleration of crystallization of the polylactic acid, which leads to improvement of heat resistance and impact resistance have been accomplished by the filler material and fatty acid amide. A conventional polylactic acid is known to be relatively weak against heat and has been limited in intended use. However, the polylactic acid of the present invention has made it possible to be used in material fields requiring heat resistance at about 80° C. or above and rigidity, especially in automobile parts. According to the method, the polylactic acid molded products can be made with good moldability, simplicity and good productivity.

### BRIEF DESCRIPTION OF THE DRAWINGS

FIG. 1 shows electron micrographs with 1000-hold magnification of metal phosphate comprised in the composition of the present invention. FIG. 1A represents a mixture of fibrous metal phosphate and granulated metal phosphate. FIG. 1B represents granulated metal phosphate, and FIG. 1C represents fibrous metal phosphate.

FIG. 2 is a graph showing an effect of adding filler to the composition of the present invention on a deflection temperature under load.

FIG. 3 is a graph showing correlation of crystallinity and a deflection temperature under load in the composition of the present invention.

FIG. 4 shows an X-ray diffraction chart of the polylactic acid product molded at 35° C. of the polylactic acid composition.

FIG. 5 shows an X-ray diffraction profile of the polylactic acid product molded at 100° C. of the polylactic acid composition.

FIG. 6 shows an X-ray diffraction profile of the polylactic acid product molded at 110° C. of the polylactic acid composition.

FIG. 7 shows an X-ray diffraction profile of the polylactic acid product molded at 35° C. of the polylactic acid composition comprising filler.

FIG. 8 shows an X-ray diffraction profile of the polylactic acid product molded at 100° C. of the polylactic acid composition comprising filler.

FIG. 9 shows an X-ray diffraction profile of the polylactic acid product molded at 110° C. of the polylactic acid composition comprising filler.

### DETAILED DESCRIPTION OT THE PREFERRED EMBODIMENT

The present invention is described in greater detail below with reference to embodiments thereof.

The present inventors actually applied the method disclosed in Japanese Patent Provisional Publication No. 4-504731 (WO 90/01521) to the production of polylactic acid products. The inventors performed injection molding in which silica, kaolinite and talc were used as the nuclear agents, but the crystallization rate was slow, crystallinity was insufficient, polymer components deteriorated and the products became fragile.

The present inventors actually applied the method the method disclosed in Japanese Patent Provisional Publication No. 6-504799 (WO 92/04413) to molding production of the polylactic acid. The inventors performed injection molding where calcium lactate and sodium benzoate are added to the polylactic acid. However, crystallization rate was slow, crystallinity was insufficient, polymer components deteriorated and the product became fragile.

The present inventors actually applied the method disclosed in Japanese Patent Provisional Publication No. 4-220456 to molding production of polylactic acid products. The inventors performed the injection molding. A polyglycolic acid is used as the nuclear agent, which added to polylactic acid. The cooled mold temperature during injection molding was Tg or above. However, the molding was not successfully performed in the condition where the mold temperature was Tg or above.

According to the first embodiment of the present invention, the polylactic acid composition comprises a polylactic acid and at least one metal phosphate of the formula (1).

The polylactic acid composition is referred to as a mixture comprising a polylactic acid as a major component. The composition may be a pellet-shape made from kneaded multiple ingredients, or may be another shape.

The polylactic polymer is referred to as a homopolymer of an L-lactic acid monomer, homopolymer of D-lactic acid monomer, random copolymer formed of an L-lactic acid monomer and D-lactic acid monomer, block copolymer formed of an L-lactic acid monomer and D-lactic acid monomer, and mixtures thereof. The polylactic polymer may comprise other copolymers having one or two or more of monomers selected from the group consisting of aliphatic hydroxycarboxylic acids other than lactic acid, aliphatic polyvalent alcohol, and aliphatic polybasic acids. The copolymer may be any of a random copolymer or block copolymer. The polylactic polymer may be a mixture of the above mentioned polymers and aliphatic polyester described in detail below, wherein at least 50% by weight of a lactic acid in terms of monomer is contained.

Aliphatic polyester may include homopolymer and copolymer of which major components are one or two or more monomers selected from the group consisting of aliphatic hydroxycarboxylic acids, aliphatic polyvalent alcohol, and aliphatic polybasic acids, and mixtures thereof. The copolymer may include a random polymer and block polymer. Aliphatic hydroxycarboxylic acid may include glycolic acid, lactic acid, hydroxybutyric acid, hydroxyvaleric acid and hydroxycaproic acid. Aliphatic polyvalent alcohol may include ethyleneglycol, propyleneglycol, butanediol, hexanediol and 1,4-cyclohexanedimethanol. Aliphatic polybasic acid may include oxalic acid, succinic acid, adipic acid, azelaic acid, malonic acid, glutaric acid, dodecanedicarboxylic acid, and anhydride thereof. Specific examples of aliphatic polyester may include polyethylene succinate, polybutylene succinate, poly(ε-caprolactone), poly(3-hydroxybutylate) and polylactic acid.

One or more additives can be added to the polylactic acid. The additives may include anti-oxidants, thermal stabilizers, ultraviolet stabilizers, lubricants, fillers, anti-static agents, agents imparting conductivity and pigments.

The metal phosphates of the formula (1) may include, but are not limited to, sodium 2,2-methylene-bis(4,6-di-tert-butylphenyl) phosphate, potassium 2,2-methylene-bis(4,6-di-tert-butylphenyl) phosphate, sodium 2,2-methylene-bis(4,6-di-methylphenyl) phosphate, aluminum 2,2-methylene-bis(4,6-di-tert-butylphenyl)phosphate hydroxide and calcium 2,2-methylene-bis(4,6-di-tert-butylphenyl)phosphate hydroxide. These metal phosphates can be uniformly dispersed in the polylactic acid to be stable numerous crystal nuclei. The nuclei promote generation of a uniform and fine crystal structure of the polylactic acid in a short period of time when the polylactic acid is crystallized. This improves the rigidity and a deflection temperature under load. The metal phosphate can remarkably accelerate crystal growth of the polylactic acid at the crystallization temperature to generate a uniform and fine crystal structure in a short period of time by a synergistic effect of the crystal growth of the polymer itself and the metal phosphate.

Preferably, the metal phosphate is sodium 2,2-methylene-bis(4,6-di-tert-butylphenyl) phosphate or aluminum 2,2-methylene-bis(4,6-di-tert-butylphenyl)phosphate hydroxide. Since the metal phosphates are industrially produced, they are preferable in terms of cost. More preferably, the metal phosphate is in a fibrous or oriented form. An oriented form is referred to as a metal phosphate having a crystal structure where a ratio of a major axis to a minor axis, or a ratio of a major axis to the thickness is large. The structure may include fiber, plate and needle. The fibrous metal phosphate is referred to as metal phosphate where the crystals with a ratio of a major axis to a minor axis of 10 or more are entangled. Such fibrous metal phosphate may be more preferable.

The metal phosphate may be used singly or as a mixture of two or more metal phosphates. The metal phosphate can be added to a polylactic acid in an amount of 1% to 2% by weight based on the weight of the polylactic acid. Preferably, the metal phosphate is an amount of 0.1% to 0.5% by weight. When the amount is less than 0.1% by weight, crystallization may not be sufficient. When the amount is more than 2% by weight, it may not be practical in terms of cost. The 0.5% or less may be more preferable because sufficient crystallization is obtained at 0.5% by weight and it is practical in terms of cost.

Next, described is the method for producing a polylactic acid molded product using the polylactic acid composition according to the first embodiment. The method for producing a polylactic acid molded product comprises steps of kneading the polylactic acid and at least one metal phosphate of the formula (1), wherein R₁, R₂, R₃, and R₄ each independently represents hydrogen or alkyl which may be the same or different, M represents a metal atom, and m and n each independently represents an integer of 1 to 3 where the m is equal to or larger than n, to prepare a composition; melting the kneaded composition and casting the composition in a mold; and molding the composition at a mold temperature within the range of the crystallization temperature of the polylactic acid.

The materials may be kneaded to prepare a composition. In the present invention, the kneading technique is not especially limited, and conventional kneading technology known to those skilled in the art can be employed. Specifically, it is possible to make pellets by mixing pellets of the polylactic acid and one or more the metal phosphates, and melting/kneading the polylactic acid and the metal phosphates at a kneading temperature of 160° C. to 190° C. using a biaxial extruder. Or it is also possible to make melted/kneaded composition into a powdered form. The kneading may be also carried out by the method using a monoaxial extruder or the method in which the metal phosphates are added to the polylactic acid during melting of the polylactic acid in an extruder.

The kneaded and pelletized composition may be melted at 180° C. to 200° C., and then molded. In the present invention, the molding step can be performed by injection molding, extrusion molding, blow molding, injection blow molding, vacuum and pressure molding, or the like. However, the molding step is not limited to the above. The molding step may be performed over 30 seconds to 5 minutes as the temperature of the mold may be retained at the crystallization temperature of the polylactic acid.

Because the crystallization temperature of the polylactic acid is about 80° C. to 140° C., it is preferable to carry out the molding step within the range of these temperatures. Preferably, the molding step may be carried out in a temperature range of about 100° C. to 120° C. when the metal phosphate is a sodium salt. Preferably, the molding step may be carried out in a temperature range of about 100° C. to 110° C. when the metal phosphate is an aluminum salt.

The molding period of time is preferably 30 seconds to 5 minutes, and more preferably 1 to 2 minutes. However, the time may be variable depending on the size of the mold and shape of the molded product. When the time is 30 seconds or shorter, the crystallization may not progress sufficiently. When the time is 5 minutes or longer, productivity of the product may become low.

Then, the molded composition is released from the mold at the temperature within the range of the crystallization temperature of the polylactic acid, which is the same as the molding temperature. Specifically the temperature may be about 80° C. to 140° C. It is considered that the releasing temperature can accelerate crystallization of the polylactic acid after the molded composition is released from the mold, and the molded composition with high crystallinity can be obtained.

According to the first embodiment of the present invention, obtained is the polylactic acid molded product with an improved deflection temperature under load and a sufficient heat resistance. According to the method, a polylactic acid product can be obtained by a simple method with high productivity. Some defects in the prior art are solved by the present unvention.

According to the second embodiment of the present invention, the polylactic acid composition may further comprise a filler material in addition to the polylactic acid and at least one of the metal phosphates of formula (1).

The polylactic acid and the metal phosphate used in the second embodiment may be same as those described in the first embodiment, so that the description thereof is omitted here. The filler material may include inorganic filler or organic filler, and the filler with low heat conductivity may be more preferable. Because the filler is considered to enhance heat energy change (ΔH) caused by the crystallization of the polylactic acid composition, the filler with low heat conductivity may reduce the cooling rate of the polylactic acid. Thus, the polylactic acid is exposed to a crystallization temperature zone for a long time to facilitate the crystallization.

The inorganic filler with low heat conductivity may include, but are not limited to, talc, silica, calcium carbonate, barium sulfate, kaolin clay, mica, montmorillonite, silicate compounds, glass fibers and mineral fibers. The organic filler may include, but are not limited to, graphite, carbon fibers, organic fibers, wood powder and bamboo powder. The above filler may be used alone or in mixture of two or more.

The filler may be added to the polylactic acid preferably in an amount of 0.1% to 50% by weight, and more preferably, at 1% to 5% by weight based on the weight of the polylactic acid. The greater the amount of the filler is, the greater the ΔH can be. Thus, the crystallinity is enhanced. It is desirable that the amount of the filler may be less than 50% by weight because the composition or the molded product of the present invention should be a produced mainly from a biodegradable raw material, which is derived from a plant.

The method for making the polylactic acid molded product can be conducted by the same procedure as the first embodiment. In the kneading step, the filler in addition to the polylactic acid and the metal phosphate can be kneaded to prepare the composition. The amount of the filler can be 0.1% to 50% by weight based on the weight of the polylactic acid.

In the second embodiment, a polylactic acid composition having an enhanced crystallinity of the polylactic acid and superior heat resistance is obtained. Such a polylactic acid product with high heat resistance and biodegradability is highly useful for components of industrial products.

According to the third embodiment, the polylactic acid composition may further comprise fatty acid amide in addition to the polylactic acid, at least one of the metal phosphates of the formula (1) and a filler material.

The polylactic acid, the metal phosphate and a filler material used in the third embodiment may be same as those described in the first and second embodiments, so that the description thereof is omitted here. The fatty acid amide may include, but is not limited to, long chain alkyl fatty acid amide such as stearamide, oleamide, erucamide, behenamide and lauramide. A fatty acid amide generally used as lubricants can be used.

The amount of the fatty acid amide may be preferably 0.3 to 5.0% by weight, and more preferably 1.0% to 2.0% by weight based on the weight of the polylactic acid. When fatty acid amide is less than 0.3% by weight, the desired impact resistance may not be sufficient. When the amount is more than 2.0% by weight, surface property of the product may be poor.

The method for producing the polylactic acid composition further comprising fatty acid amide may be nearly the same as the method of the foregoing second embodiment. In the kneading step, the fatty acid amide can be mixed to the polylactic acid, the metal phosphate and the filler. the fatty acid amide can be added in an amount of 0.3 to 5.0% by weight based on the weight of the polylactic acid.

According to the third embodiment a polylactic acid product with improved heat resistance and impact resistance may be provided. In the polylactic acid molded product, the crystallinity may be enhanced and a deflection temperature under load is also raised. The molded products may be useful for car components.

According to the fourth embodiment, the polylactic acid product may have a crystal structure where the crystallinity is 25% or more, the lattice spacing of the crystals is 5.2 to 5.5 angstroms, and the crystallite size is 400 angstroms or less.

The polylactic acid molded product of the fourth embodiment can be produced according to the polylactic acid composition in any of the foregoing first to third embodiments using the method. The crystallinity, a lattice spacing of the crystal and a crystallite size of the product can be obtained by analyzing X-ray diffraction profile of the crystal structure using predetermined software. Such technique for crystal analysis is well known to those skilled in the art.

According to the fourth embodiment, a polylactic acid product having improved heat resistance and impact resistance may be provided. The molded product can be useful for car components.

### EXAMPLES

The present invention is described in greater detail below by showing examples. The following examples do not intend to limit the present invention.

In the following examples and comparative examples, the polylactic acid products were produced from various kinds of compositions at various mold temperatures, and the properties of these products were evaluated. The method for producing test pieces and the test method are common in all examples and comparative.

<Kneading of Materials>

The metal phosphates (brand name: ADK STAB NA-11, NA-11SF, NA-11UF, NA-21 supplied by Asahi Denka Kogyo Co., Ltd.) were mixed at a prescribed amount with pellets of polylactic acid (grade: LACTY 9030 supplied by Shimadzu Corporation) or pellets where polylactic acid and polybutylene succinate (grade: Bionolle 1020 supplied by Showa Highpolymer Co., Ltd.) were mixed at a weight ratio of 4:1. In some comparative examples, benzylidene sorbitol derivatives (brand name: NC-4 supplied by Mitsui Chemicals Inc. or brand name: Gelall supplied by New Japan Chemical Co., Ltd.), which are not the metal phosphate, were used as a nuclear agent.

In examples using a filler material, in addition to these ingredients, talc (Hi-filler 5000JP supplied by Matsumura Sangyo KK), graphite (SGP-3 supplied by SEC Corporation) or silica (SF-CX supplied by Tomoe Engineering Co., Ltd.) was added at a prescribed amount and mixed. In examples further using fatty acid amide, stearamide (supplied by Wako Pure Chemical Industries Ltd.) was added at a prescribed amount and mixed. The mixture obtained in this way was melted/kneaded at a temperature of 160° C. to 190° C. using a biaxial extruder (supplied by Kobe Steel, Ltd.) to be pelletized.

<Manufacture of Test Pieces>

A test piece (80×10×4 mm) defined in JIS (Japan Industrial Standard) K7152-1 was produced from pelletized composition by injection molding using the biaxial extruder at a melting temperature of 180° C. to 200° C. and at a mold temperature of 35° C. to 120° C.

<Test Method>

1) Measurement was carried out under the following condition according to the test method defined in a deflection temperature under load, JIS K7191.

[Test Condition]

Load: 0.45 MPa (4.6 kg/m²)

Distance between a supporting table and a supporting point: 64 mm

Radius R of the supporting table indenter=3.0 mm

Temperature raising rate: 2° C./min

Standard deflection: 0.34 mm

2) Measurement was carried out under the following conditions according to the test method defined in bending test, JIS K7171.

[Test Condition]

Radius R of the supporting table indenter=5.0 mm

Bending rate: 2 mm/min

Distance between supporting points: 64 mm

3) Measurement was carried out according to the test method defined in the Charpy impact test, JISK7111 by giving a notch to the test piece.

### Example 1

To 100 parts by weight of polylactic acid, 0.5 or 1.0 parts by weight of aluminum 2,2-methylene-bis(4,6-di-tert-butylphenyl) phosphate hydroxide(brand name: ADK STAB NA-21 supplied by Asahi Denka Co., Ltd.) or sodium 2,2-methylene-bis(4,6-di-tert-butylphenyl) phosphate (brand name: ADK STAB NA-11) was mixed, and pellets were made by the foregoing kneading step. Using the pellets, test pieces were made at a mold temperature of 100° C., 110° C. or 120° C. by the foregoing method for making the test piece, and a deflection temperature under load was measured. As is shown from the results in Table 1, a deflection temperature under load was significantly raised.

### Comparative Example 1

To 100 parts by weight of polylactic acid, 0.1, 0.5, or 1.0 parts by weight of Gelall DH or NC-4 was added, and pellets were made by the kneading method. Using the pellets, molding of test pieces was carried out at the mold temperature of 100° C., 110° C. or 120° C. by the foregoing method for making the test piece. As shown in Table 1, deformation of the test piece occurred upon releasing the molded composition from the mold and the molding was not successfully performed. With respect to the material of polylactic acid alone without the nuclear agent, the molding was not successfully performed.

TABLE 1
A deflection temperature under load by the mold temperature
equal to or more than glass transition temperature (° C.)

| | | Amount of | Mold | Mold | Mold |
|---|---|---|---|---|---|
| | | nuclear agent | temperature | temperature | temperature |
| | Nuclear agent | (wt %) | at 100° C. | at 110° C. | at 120° C. |
| Example 1 | Aluminum 2,2- | 0.5 | 98.1 | 66.7 | Impossible |
| | methylene-bis(4,6-di- | 1.0 | 103.9 | 129.8 | to mold |
| | tert- | | | | |
| | butylphenyl) phosphate | | | | |
| | hydroxide (ADK STAB | | | | |
| | NA-21) | | | | |
| | Sodium 2,2-methylene- | 0.5 | Impossible | 58.8 | 58.7 |
| | bis(4,6-di-tert- | 1.0 | to mold | 64.9 | 65.5 |
| | butylphenyl) | | | | |
| | phosphate (ADK STAB | | | | |
| | NA-11) | | | | |
| Comparative | NC4 | 0.1, 0.5, | Impossible | Impossible | Impossible |
| Example 1 | | 1.0 | to mold | to mold | to mold |
| | Gelall DH | 0.1, 0.5, | Impossible | Impossible | Impossible |
| | | 1.0 | to mold | to mold | to mold |
| | No addition | — | Impossible | Impossible | Impossible |
| | (polylactic acid | | to mold | to mold | to mold |
| | alone) | | | | |

### Example 2

To 100 parts by weight of polylactic acid, 0.1, 0.5, or 1.0 parts by weight ADK STAB NA-11 (supplied by Asahi Denka Co., Ltd.) or ADK STAB NA-21 was mixed respectively, and pellets were made by the foregoing kneading method. Using the pellets, a test piece was made at the mold temperature of 35° C. by the foregoing method for making the test piece, and a deflection temperature under load was measured. As is shown from the results in Table 2, no improved deflection temperature under load was observed in the test piece with the nuclear agents molded at a mold temperature of 35° C.

### Comparative Example 2

To 100 parts by weight of polylactic acid, 0.1, 0.5 or 1.0 parts by weight of Gelall DH (supplied by New Japan Chemical Co., Ltd.) or NC-4 (supplied by Mitsui Chemicals) as a nuclear agent, was mixed, so that pellets were obtained. Pellets without any nuclear agent were also prepared as the same way. A test piece was molded at a mold temperature of 35° C. by the foregoing method for making the test piece, and a deflection temperature under load was measured. As is shown from the results in Table 2, no improved deflection temperature under load was observed in the test piece with the nuclear agents molded at a mold temperature of 35° C.

TABLE 2
A deflection temperature (° C.) under load by the mold
temperature (35° C.) recommended by the maker of
polylactic acid

| | | Addition amount of nuclear agent | | | |
|---|---|---|---|---|---|
| | | | 0.1 | 0.5 | |
| | Added nuclear agent | 0 wt % | wt % | wt % | 1.0 wt % |
| Example 2 | ADK STAB NA-11 | | 54.2 | 54.1 | 54.2 |
| | ADK STAB NA-21 | | 54.5 | 53.5 | 52.9 |
| Comparative | NC4 | | 54.0 | 54.1 | 54.0 |
| Example 2 | Gelall DH | | 54.6 | 54.2 | 54.1 |
| | No addition | 54.5 | | | |

### Example 3

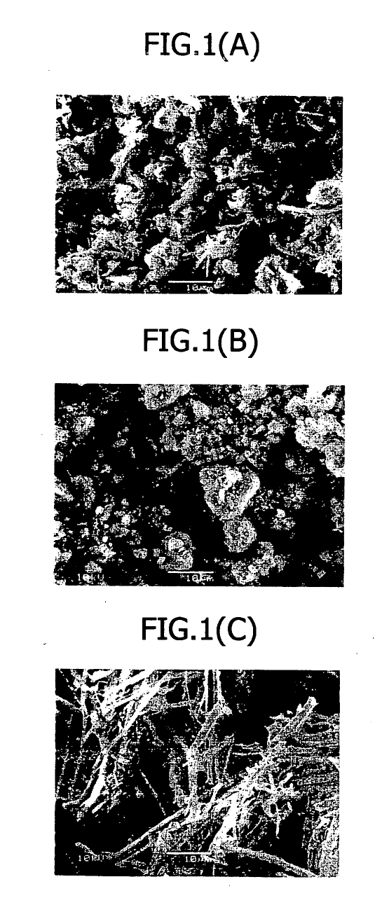

To 100 parts by weight of polylactic acid, 1.0 parts by weight of 3 types of sodium 2,2-methylene-bis(4,6-di-tert-butylphenyl) phosphate (brand names: ADK STAB NA-11, NA-11SF or NA-11UF), which was different in shape as shown in FIG. 1, were mixed and pellets were made by the foregoing kneading method. Using the pellets, a test piece was molded at a mold temperature of 35° C., 100° C. or 110° C. by the foregoing method for making the test piece, and a bending elastic modulus was measured. As is shown from the results in Table 3, in the product contained a fibrous-shaped metal phosphate, the bending elastic modulus was the highest.

### Comparative Example 3

Using the polylactic acid alone without nuclear agents, a test piece was molded as with Example 3 at a mold temperature of 35° C. or 100° C. or 110° C., and the bending elastic modulus was measured. As is shown from the results in Table 3, the molding was not successfully performed at a mold temperature of 100° C. or 110° C. In the test piece consisting of a polylactic acid alone, a bending elastic modulus was the lowest.

TABLE 3
An effect of adding metal phosphates of different shapes on
bending elastic modulus (MPa)

| | | Addition | Mold | Mold | Mold |
|---|---|---|---|---|---|
| | Shape of metal | amount | temperature | temperature | temperature |
| | phosphate | (wt %) | at 35° C. | at 100° C. | at 110° C. |
| Example 3 | Mixture of fibrous and | 1.0 | 3530 | 3480 | 3490 |
| | granular shapes (ADK | | | | |
| | STAB NA-11) | | | | |
| | Granular shape | 1.0 | 3590 | 3690 | 3860 |
| | (ADK STAB 11SF) | | | | |
| | Fibrous shape | 1.0 | 3650 | 3820 | 3980 |
| | (ADK STAB NA-11UF) | | | | |
| Comparative | No addition | — | 3530 | Impossible | Impossible |
| Example 3 | (polylactic acid alone) | | | to mold | to mold |

### Example 4

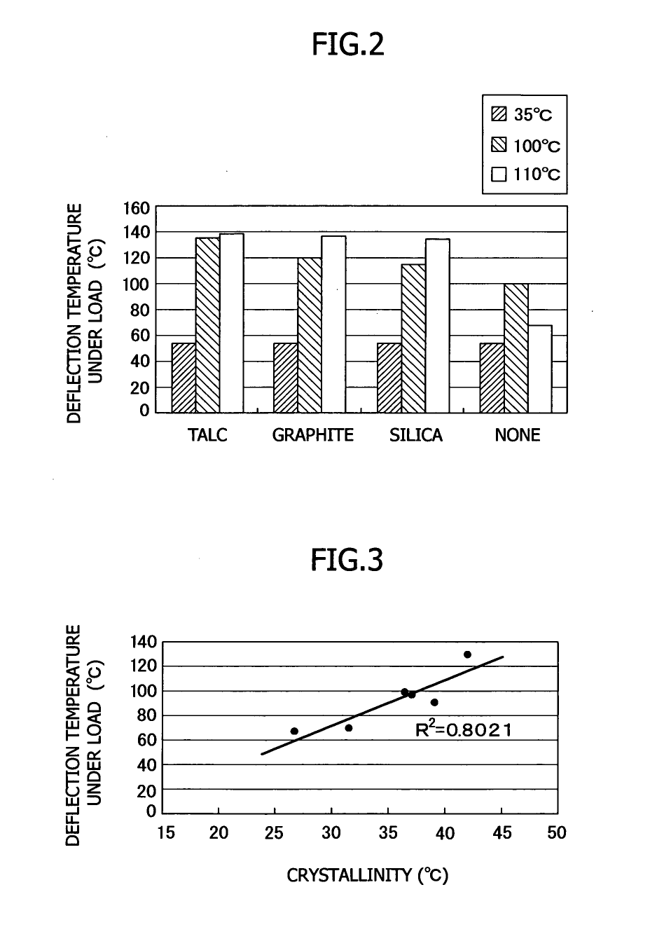

To 100 parts by weight of polylactic acid, 0.5 parts by weight of aluminum 2,2-methylene-bis(4,6-di-tert-butylphenyl) phosphate hydroxide(brand name: ADK STAB NA-21 supplied by Asahi Denka Co., Ltd.) and 1.0 parts by weight of talc (Hi-lo filler 5000JP supplied by Matsumura Sangyo KK), graphite (SGP-3 supplied by SEC Corporation) or silica (SF-CX supplied by Tomoe Engineering Co., Ltd.) as the filler were mixed, and pellets were made by the foregoing kneading method. Also, pellets without filler were made. Using the pellets, test pieces were molded at a mold temperature of 35° C. or 100° C. or 110° C. by the foregoing method for making the test piece. A deflection temperature under load was measured. As is shown from the results in FIG. 2, in the test piece containing the filler and the molded at a mold temperature of 100° C. or 110° C., a deflection temperature under load was enhanced. A change of a heat energy (ΔH) caused by the crystallization of each material was measured by DSC (Differential Scanning Calorimetry supplied by Shimadzu Corporation). As is shown from the results in Table 4, the change in heat energy (ΔH) caused by the crystallization, which is an index of the crystallization rate was enhanced by the filler. In particular, talc is highly effective for enhancing the crystallization. In the test piece not containing the filler, as is shown in FIG. 2 and Table 4, a deflection temperature under load and ΔH were the lowest.

TABLE 4
An effect of filler on crystallinity

| | | Change in heat energy |
|---|---|---|
| | Filler | (ΔH) (J/g) |
| Example 4 | Talc (1.0 wt %) | 37.2 |
| | Graphite (1.0 wt %) | 30.9 |
| | Silica (1.0 wt %) | 29.3 |
| | No addition | 24.6 |

### Example 5

The 0.3 parts by weight of Aluminum 2,2-methylene-bis(4,6-di-tert-butylphenyl) phosphate hydroxide, 1.0 parts by weight of talc and 0 or 0.3 or 1.5 parts by weight of stearamide were mixed to 100 parts by weight of resin. The resin is referred to as a mixture of a polylactic acid and polybutylene succinate (Bionolle 1001 supplied by Showa Highpolymer Co., Ltd.) in a weight ratio of 80:20. Pellets were made by the foregoing kneading method. Using the pellets, a test piece was molded at a mold temperature of 35° C., 100° C. or 110° C. by the foregoing method for making the test piece, and a deflection temperature under load and Charpy impact value (by JISK7111) were measured. As is shown from the results in Table 5, when the mold temperature was 100° C. or 110° C., a deflection temperature under load was enhanced by the stearamide, and the impact resistance was the highest when 1.5 parts by weight of the stearamide was added. In the test peace containing 1.5 parts by weight of stearamide and molded at a temperature of 35° C., the impact resistance was enhanced but a deflection temperature under load was low and was 51° C.

TABLE 5
An effect of stearamide on impact resistance

| | | | | Deflection |
|---|---|---|---|---|
| | | Mold | | temperature |
| | Stearamide | temperature | Charpy impact | under load |
| | (wt %) | (° C.) | value (kJ/m²) | (° C.) |
| Example 5 | 0 | 100 | 1.6 | 90.2 |
| | | 110 | 1.6 | 97.1 |
| | 0.3 | 100 | 1.4 | 92.3 |
| | | 110 | 1.4 | 104.6 |
| | 1.5 | 100 | 2.9 | 95.9 |
| | | 110 | 3.2 | 97.7 |
| | 0 | 35 | 1.7 | 52.2 |
| | 0.3 | 35 | 1.6 | 51.2 |
| | 1.5 | 35 | 2.5 | 51.1 |

### Example 6

Among the polylactic acid products made in Examples 1, 2, 4 and 5, the crystal structures of the products having the constitution and molded at a mold temperature listed in the following Table 6 were analyzed by X-ray diffraction (RINT 2000 supplied by Rigaku Corporation). In the table, the resin is referred to as the polylactic acid, and PLA and PBS are referred to as polylactic acid and polybutylene succinate, respectively. The crystallinity and the crystallite size were obtained form the resulting diffraction profiles using included software (software name: JADE). From the results shown in Table 6, the products having an enhanced deflection temperature under load had a crystal structure where the lattice spacing of the crystal is 5.2 to 5.5 angstroms, and the crystal size was 400 angstroms or less.

FIG. 3 is a graph showing a relation of a deflection temperature under load and the crystallinity in the polylactic acid products wherein the lattice spacing of the crystal is 5.2 to 5.5 angstroms. As shown in FIG. 3, in the temperature range, when the crystallinity was 25% or more, there was a correlation of R²=0.8021 between a deflection temperature under load and the crystallinity, and thus a deflection temperature under load was enhanced in proportion to the crystallinity. Therefore, it was found that the polylactic acid product having a certain crystal structure is excellent in heat resistance.

TABLE 6
Crystal structure analysis by X-ray diffraction

| | | | Amount of | | | | | |
|---|---|---|---|---|---|---|---|---|
| | | | Aluminum 2,2- | | | | | |
| | | | methylene- | | | | | |
| | | | bis (4,6-di- | | | | | |
| | | | tert- | | | | | Deflection |
| | Example or | | butylphenyl) | | Mold | Crystallite | | temperature |
| | Comparative | | phosphate | Amount | temperature | size | Crystallinity | under |
| No. | example No. | Resin | hydroxide | of talc | (° C.) | (Å)^{note)} | (%) | load (° C.) |
| 1 | Example 2 | PLA | 0.5 wt % | — | 35 | — | 0 | 53.5 |
| 2 | Example 1 | | | | 100 | 341 | 36.7 | 98.1 |
| 3 | | | | | 110 | 297 | 26.8 | 66.7 |
| 4 | Example 2 | | 1.0 wt % | — | 35 | — | 0 | 52.9 |
| 5 | Example 1 | | | | 100 | 393 | 31.5 | 68.6 |
| 6 | | | | | 110 | 313 | 42.1 | 129.8 |
| 7 | Example 4 | | 0.5 wt % | 1.0 wt % | 35 | — | 13.2 | 53.4 |
| 8 | Example 5 | PLA80% + | 0.3 wt % | 1.0 wt % | 35 | — | 15.9 | 52.2 |
| 9 | | PBS20% | | | 100 | 273 | 39.1 | 90.2 |
| 10 | | | | | 110 | 264 | 37.1 | 97.1 |

^{note)}
The crystallite sizes are of those having a crystal structure where the lattice spacing is 5.2 to 5.5 angstroms. Those not having a crystal structure where the lattice spacing is 5.2 to 5.5 angstroms are represented by “—.”

### Example 7

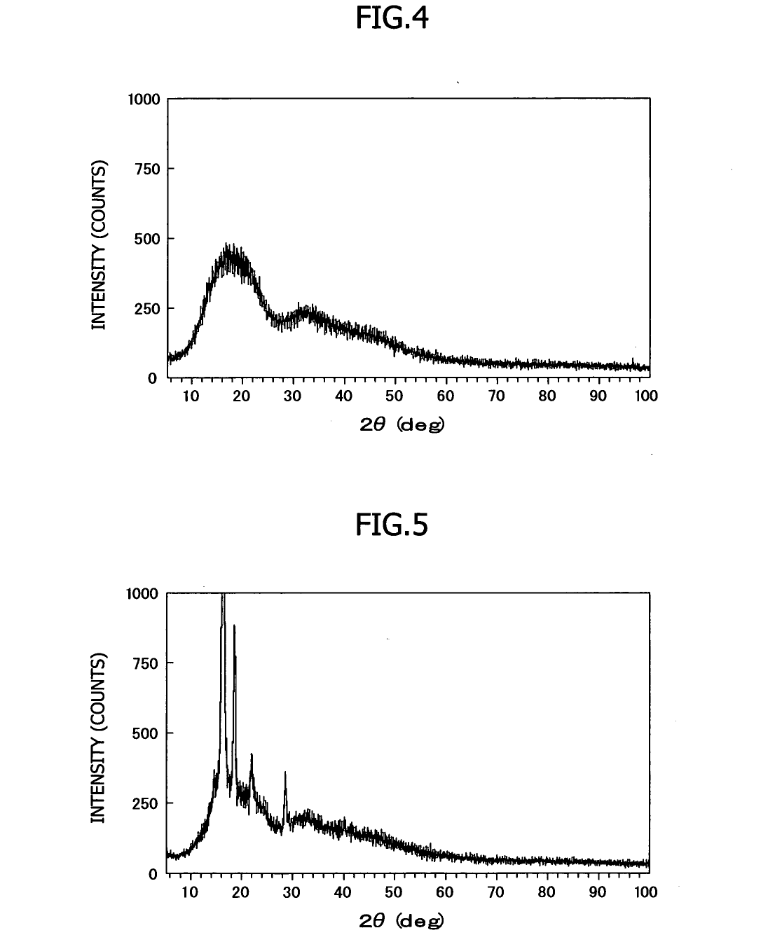

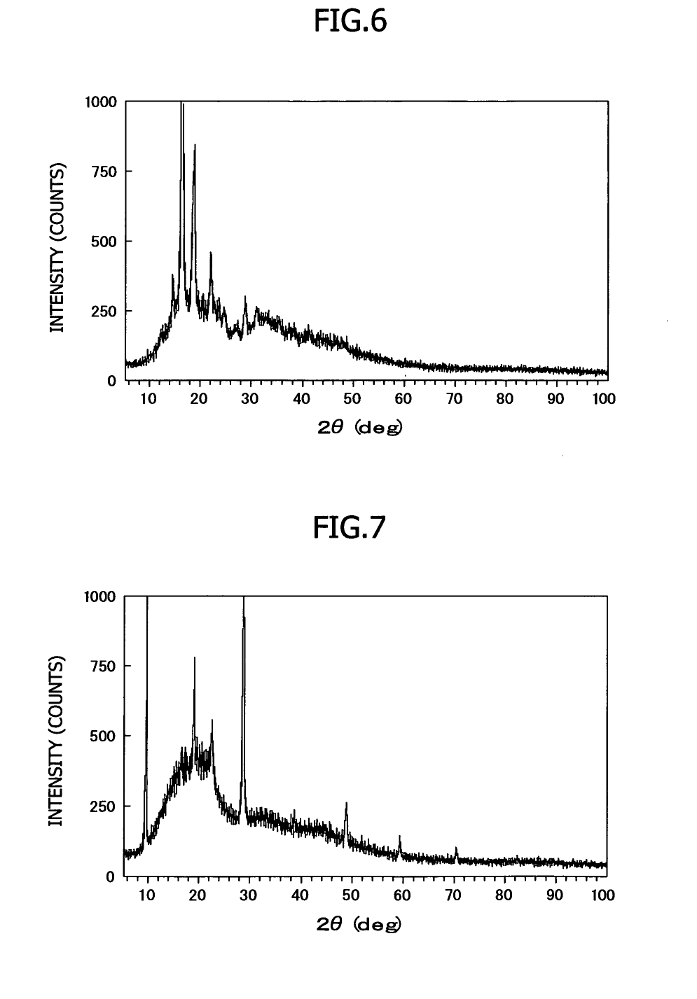

The polylactic acid composition was molded at a prescribed temperature to make polylactic acid products. The products were analyzed by X-ray diffraction (RINT 2000 supplied by Rigaku Corporation). In Example 7, prepared was a polylactic acid composition in which 0.5% by weight of aluminum 2,2-methylene-bis(4,6-di-tert-butylphenyl) phosphate hydroxide was added as the metal phosphate to a base resin composed of 100% polylactic acid. The products obtained by molding at 35° C. over 0 seconds, one obtained at 100° C. over 90 seconds and one obtained at 110° C. over 90 seconds were analyzed. The results of analysis are shown in FIGS. 4, 5 and 6. FIGS. 4, 5 and 6 are X-ray diffraction profiles obtained from the products molded at 35° C., 100° C. and 110° C., respectively. No peak indicating the presence of the crystal was observed in the profile of the product molded at 35° C. The polylactic acid product having good crystallinity was not obtained at 35° C.

### Example 8

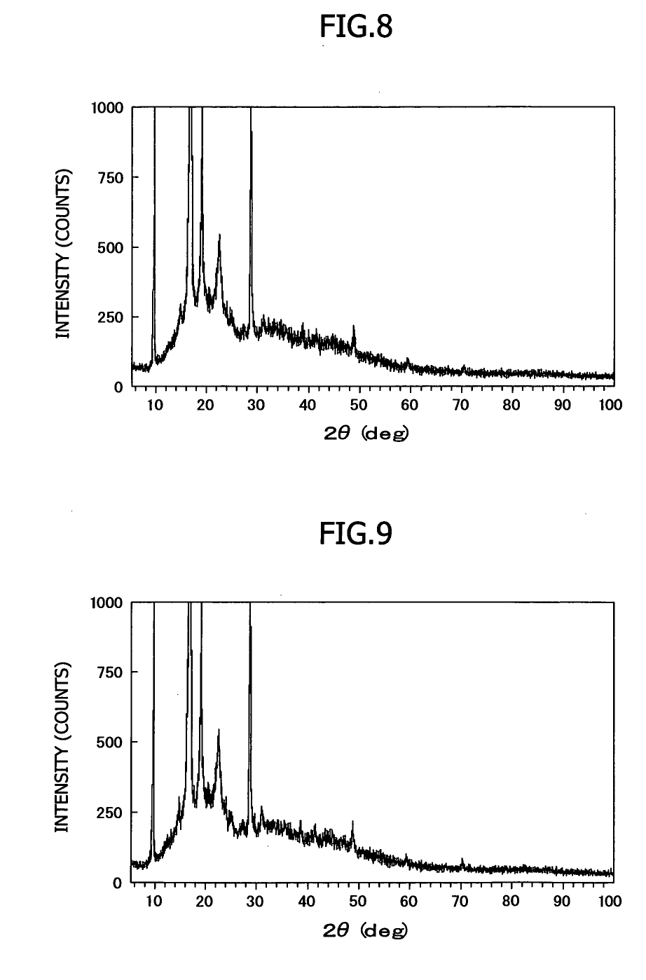

By the same method as that in Example 7, polylactic acid compositions further comprising the filler were prepared and molded at a prescribed temperature, and the molded products were analyzed by X-ray diffraction (RINT 2000 supplied by Rigaku Corporation). In Example 8, prepared was the polylactic acid composition in which 0.5% by weight of aluminum 2,2-methylene-bis(4,6-di-tert-butylphenyl) phosphate hydroxide was added as the metal phosphate and 1% by weight of talc was added as the filler to a base resin composed of 80% by weight of polylactic acid and 20% by weight of polybutylene succinate (grade: Bionolle 1020 supplied by Showa Highpolymer Co., Ltd.). The products obtained by the molding at 35° C. over 0 seconds, the products obtained at 100° C. over 90 seconds and the products obtained at 110° C. over 90 seconds were analyzed by X-ray diffraction. The results of analysis are shown in FIGS. 7, 8 and 9. FIGS. 7, 8 and 9 are X-ray diffraction profiles obtained from the products molded at 35° C., 100° C. and 110° C., respectively. No peak indicating the presence of the crystal was observed in the product molded at 35° C. The polylactic acid product having good crystallinity was not obtained at 35° C.

As is shown in the present examples and the comparative examples, the polylactic acid products obtained by molding the composition comprising a polylactic acid and metal phosphates at the prescribed temperature elevated a deflection temperature under load. Further, the fatty acid amide improved impact resistance of the product.

1. A polylactic acid composition comprising polylactic acid and at least one metal phosphate of the formula: 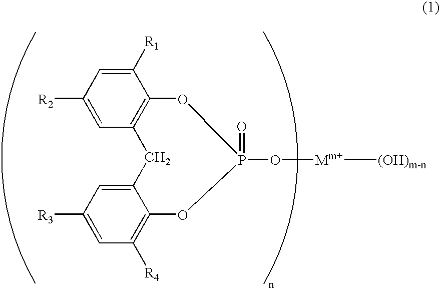
wherein R₁, R₂, R₃, and R₄ each independently represents hydrogen or alkyl, which may be the same or different, m represents a metal atom, and m and n each independently represents an integer of 1 to 3 where the m is equal to or larger than n:

2. The polylactic acid composition according to claim 1 wherein said metal phosphate is sodium 2,2-methylene-bis(4,6-di-tert-butylphenyl) phosphate or aluminum 2,2-methylene-bis(4,6-di-tert-butylphenyl)phosphate hydroxide.

3. The polylactic acid composition according to claim 1 wherein said metal phosphate is in a fibrous or oriented form.

4. The polylactic acid composition according to claim 1 wherein said metal phosphate is contained in amount of 0.1% 2% by weight based on the weight of the polylactic acid.

5. The polylactic acid composition according to claim 1 further comprising one or more filler selected from the group consisting of talc, graphite and silica.

6. The polylactic acid composition according to claim 1 further comprising fatty acid amide.

7. The polylactic acid composition according to claim 1 further comprising one or more filler selected from the group consisting of talc, graphite and silica and fatty acid amide.

8. A polylactic acid product molded by molding the polylactic acid composition according to claim 1, the product comprising a crystal structure having a crystallinity of 25% or more, a lattice spacing of 5.2 to 5.5 angstroms and a crystallite size of 400 angstroms or less.

9. A method for making a molded product of a polylactic acid comprising steps of:
kneading a polylactic acid and at least one metal phosphate of the formula: 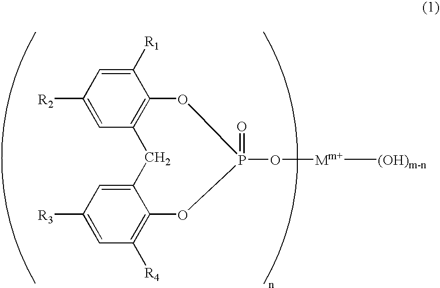
wherein R₁, R₂, R₃, and R₄ each independently represents hydrogen or alkyl, which may be the same or different, M represents a metal atom, and m and n each independently represents an integer of 1 to 3 where the m is equal to or larger than n, to prepare a composition;
melting the kneaded composition and casting the composition in a mold; and
molding the composition by retaining the mold at a temperature within a crystallization temperature range of the polylactic acid.

10. The method according to claim 9, further comprising a step of releasing the molded composition from the mold at the mold temperature.

11. The method according to claim 9 wherein the crystallization temperature range of the polylactic acid is 80° C. to 140° C.

12. A polylactic acid molded product made by the method according to claim 9.
